(19) United States
(12) Patent Application Publication
(10) Pub. No.: US 2016/0088091 A1
(43) Pub. Date: Mar. 24, 2016

(54) Identifying Existing Synchronous Communication Sessions Associated with a User

(71) Applicants: Kathryn Chapman Cushing, San Francisco, CA (US); David S. Bennett, Issaquah, WA (US); Alexander Jan Verhage, Oakland, CA (US); Gregory Matthew Marra, San Francisco, CA (US); Jeffrey Dean Grimes, Palo Alto, CA (US)

(72) Inventors: Kathryn Chapman Cushing, San Francisco, CA (US); David S. Bennett, Issaquah, WA (US); Alexander Jan Verhage, Oakland, CA (US); Gregory Matthew Marra, San Francisco, CA (US); Jeffrey Dean Grimes, Palo Alto, CA (US)

(73) Assignee: GOOGLE INC., Mountain View, CA (US)

(21) Appl. No.: 13/434,454

(22) Filed: Mar. 29, 2012

Related U.S. Application Data
(60) Provisional application No. 61/569,130, filed on Dec. 9, 2011.

(51) Int. Cl. H04L 29/08

(52) U.S. Cl. CPC H04L 67/14

(57) ABSTRACT

Existing synchronous communication sessions associated with a user are identified. A request to display information about the user is received. A plurality of existing synchronous communication sessions is identified. Each existing synchronous communication session includes at least one participant and is associated with a user. An affinity score for each of the plurality of synchronous communication sessions is determined based on an affinity between the user and at least one of the participants of the synchronous communication session. The plurality of existing synchronous communication sessions associated with the user is ranked based on the affinity score. An indication of a subset of the plurality of existing synchronous communication sessions is sent for display on the one more computing devices. In some embodiments, an indication of one of the existing synchronous communication sessions is sent for display on the one more computing devices.

The present disclosure relates to identifying existing synchronous communication sessions. More particularly, the present disclosure relates to identifying existing synchronous communication sessions associated with a particular user.

### BACKGROUND

The development of the Internet has provided convenient and efficient tools for users to stay in communication with each other. Specifically, the Internet has provided useful tools for users to engage in real-time audio and video communication with each other. Recently, social network portals have also added this capability to their functionality.

Historically, if users wanted to engage is in this type of communication, the user had to proactively invite specific users to also engage. A user may also search for existing on-line text-based chat rooms. However, it may be quite cumbersome and time-consuming to find text-based chat rooms that have participants that the user wants to chat with. Existing social networks provide the capability for users to engage in one-on-one communication with their connections in their social network and even have indications of which connections are currently on-line. However, these indications typically show a listing of which of the users connections is on-line. Therefore, it would be beneficial for users to have convenient access to communication sessions that are most relevant to the user.

### SUMMARY

The present embodiments overcome the deficiencies and limitations of the prior art by providing a system and method for identifying existing synchronous communication sessions associated with a particular user.

A method of identifying existing synchronous communication sessions associated with a user is performed by one or more computing devices. A request to display information about the user is received at the one or more computing devices. A plurality of existing synchronous communication sessions is identified. Each existing synchronous communication session includes at least one participant and the user has an association with the existing synchronous communication session. An affinity score for each of the plurality of synchronous communication sessions is determined based on an affinity between the user and at least one of the participant of the synchronous communication session. The plurality of existing synchronous communication sessions associated with the user is ranked based on the affinity score. In some embodiments, an indication of a subset of the plurality of existing synchronous communication sessions is sent for display on the one more computing devices. In some embodiments, an indication of one of the existing synchronous communication sessions is sent for display on the one more computing devices.

A system for identifying existing synchronous communication sessions associated with a user is also disclosed. A request to display information about the user is received by a request receiver. A sessions identifier identifies a plurality of existing synchronous communication sessions. Each existing synchronous communication session includes at least one participant and the user has an association with the existing synchronous communication session. An affinity score for each of the plurality of synchronous communication sessions is determined by a sessions ranking module based on an affinity between the user and at least one of the participant of the synchronous communication session. The plurality of existing synchronous communication sessions associated with the user is ranked based on the affinity score. In some embodiments, an output generator sends an indication of a subset of the plurality of existing synchronous communication sessions for display on the one more computing devices. In some embodiments, the output generator sends an indication of one of the existing synchronous communication sessions for display on the one more computing devices.

### BRIEF DESCRIPTION OF THE DRAWINGS

The embodiments are illustrated by way of example, and not by way of limitation in the figures of the accompanying drawings in which like reference numerals are used to refer to similar elements.

FIG. 1 is a block diagram illustrating a social network system for identifying existing synchronous communication sessions associated with a user according to one embodiment.

FIG. 2 is a block diagram of an embodiment of a social network server device in accordance with one embodiment.

FIG. 3 is a block diagram of an embodiment of a sessions identifier module in accordance with on embodiment.

FIG. 4 is a block diagram of an embodiment of a sessions ranking module in accordance with on embodiment.

FIG. 5 is a flow chart illustrating an embodiment of a method for identifying existing communications sessions associated with a user in accordance with one embodiment.

FIG. 6 is an example of a graphical user interface showing a notification of existing communication sessions associated with a user in accordance with one embodiment.

FIG. 7 is example of another graphical user interface showing a notification of existing communication sessions associated with a user in accordance with one embodiment.

FIG. 8 is a flow chart illustrating another embodiment of a method for identifying existing communications sessions associated with a user in accordance with another embodiment.

FIG. 9 is an example of a graphical user interface showing a notification of existing communication sessions associated with a user in accordance with another embodiment.

FIG. 10 is example of another graphical user interface showing a notification of existing communication sessions associated with a user in accordance with yet another embodiment.

### DETAILED DESCRIPTION

A system and method for identifying existing synchronous communication sessions associated with a user is described. In an example embodiment, a user logs into a social network portal. The user has the ability to participate in synchronous communication sessions through the social network portal. The user also has connections (e.g., friends or people in the user's “circles”) within the social network portal and the connections may be categorized into groups or organized into categories based on various factors. For example, the user may have a group of connections for members who are family members. The user may also have a group of connections for members who are co-workers. The social network portal provides the capability for the user to group the connections into different groups and engage in synchronous communication sessions with the members of the group. When a user logs on, the user can automatically see information about live synchronous communication sessions that are most relevant to the user. In some embodiments, the system automatically shows the user information about the X (e.g., three) most relevant synchronous communication sessions and gives the user the ability to join the live synchronous communication sessions. The relevance of the synchronous communication sessions may be determined by the system based on social affinity of the user with the users in the synchronous communication sessions, the history of the user engaging in synchronous communication sessions, the coherence of the participants in the synchronous communication sessions, and other techniques described herein.

In the following description, for purposes of explanation, numerous specific details are set forth in order to provide a thorough understanding of the embodiments. It will be apparent, however, to one skilled in the art that the embodiments can be practiced without these specific details. In other instances, structures and devices are shown in block diagram form in order to avoid obscuring the embodiments. For example, the present disclosure is described in one embodiment below with reference to user interfaces and particular hardware. However, the present disclosure applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Furthermore, embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

### System Overview

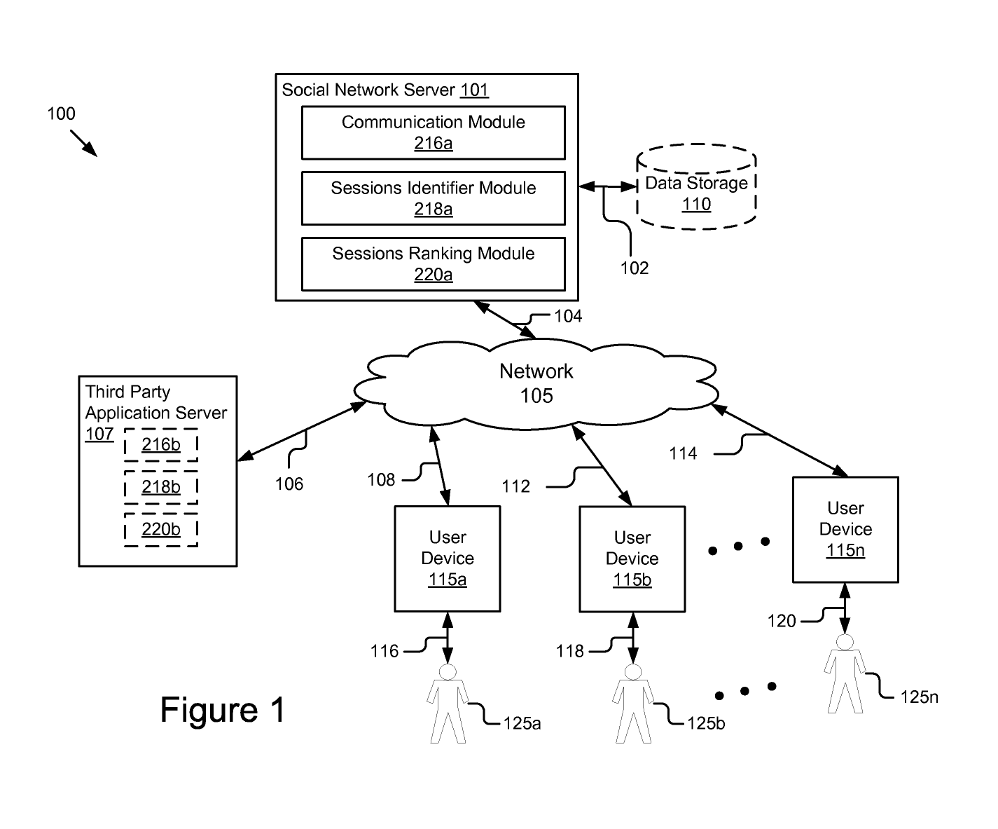

FIG. 1 illustrates a block diagram of a social network system 100 for identifying existing synchronous communication sessions associated with a user according to one embodiment. The illustrated social network system 100 includes user devices 115a, 115b, and 115n (also referred to collectively as user devices 115 or individually as user device 115) that are accessed by users 125a, 125b, and 125n (also referred to collectively as users 125 or individually as user 125), a social network server 101 and a third party application server 107. In the illustrated embodiment, these entities are communicatively coupled via a network 105. Although only three user devices 115a/115b/115n are illustrated, any number of user devices 115a/115b/115n are available to any number of users 125a/125b/125n.

The illustrated embodiments of a social network system 100 includes user devices 115a, 115b that are accessed by users 125a, 125b, a social network server 101 that is coupled to data storage 110 and a third party application server 107. In the illustrated embodiment, these entities are communicatively coupled via a network 105. The user devices 115a, 115b, 115n in FIG. 1 are used by way of example. While FIG. 1 illustrates three devices, the present disclosure applies to any system architecture having one or more user devices. Furthermore, while only one network 105 is coupled to the user devices, 115a, 115b, 115n the social network server 101 and the third party application server 107, in practice any number of networks 105 can be connected to the entities.

Although only one social network server 101 is shown, it will be recognized that multiple servers may be present. A social network is any type of social structure where the users are connected by a common feature. Examples include, but are not limited to, blogs, microblogs and Internet forums. The common feature includes friendship, family, a common interest, etc.

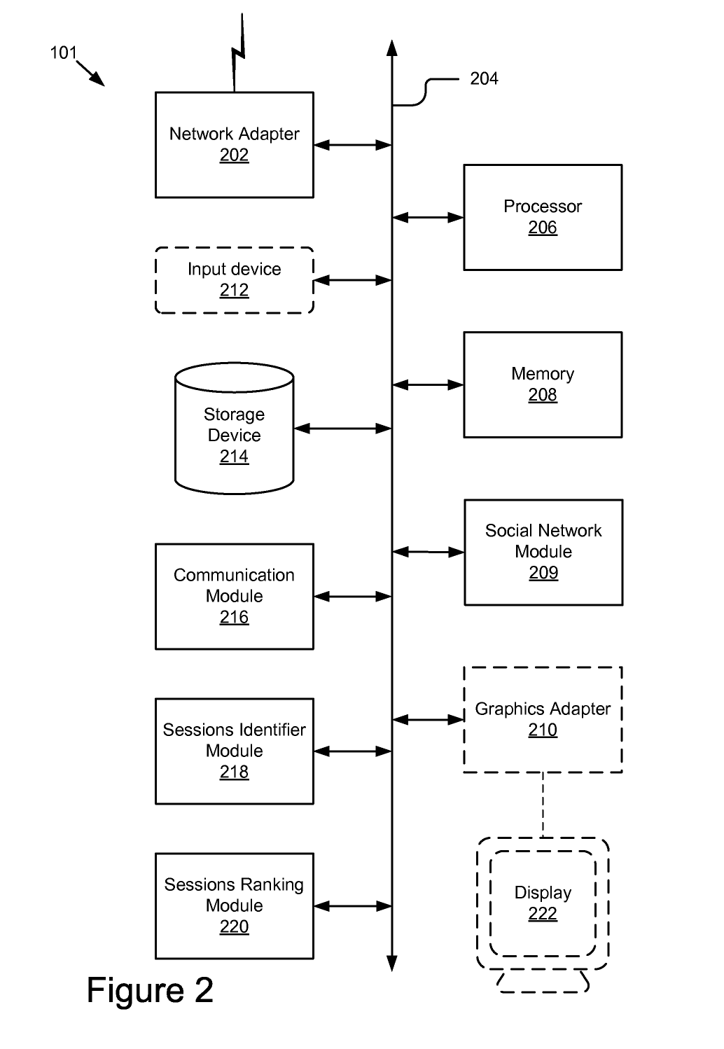

In one embodiment, the social network server 101 is coupled to the network 105 via signal line 104. The social network server 101 also includes a social network module 209 (as will be shown in FIG. 2). Although only one social network server 101 is shown, persons of ordinary skill in the art will recognize that multiple servers may be present. A social network is any type of social structure where the users are connected by a common feature, for example, Orkut. The common feature includes relationships/connections, e.g., friendship, family, work, an interest, etc. The common features are provided by one or more social networking systems, such as those included in the system 100, including explicitly-defined relationships and relationships implied by social connections with other online users, where the relationships form a social graph. In some examples, a social graph can reflect a mapping of these users and how they are related. Furthermore, it should be understood that social network server 101 and social module 209 (FIG. 2) are representative of one social network and that there may be multiple social networks (not shown) coupled to the network 105, each having its own server, application and social graph (not shown). For example, a first social network may be more directed to business networking, a second more directed to or centered on academics, a third is more directed to local business, a fourth directed to dating and others of general interest or a specific focus.

As shown in FIG. 1, according to one embodiment, social network server 101, includes, among various other modules, a communication module 216a, a sessions identifier module 218a and a sessions ranking module 220a. More details describing the features and functionalities of these modules will be discussed further below in the detailed description of FIGS. 2, 3 and 4.

In some embodiments, similar modules are included in the third party application server 107. As shown in FIG. 1, in some embodiments, third party application server 107 includes a communication module 216b, a sessions identifier module 218b and a sessions ranking module 220b. For purposes of illustration, communication module 216a/216b will be referred to as communication module 216. Sessions identifier module 218a/218b will be referred to as sessions identifier module. Lastly, sessions ranking module 220a/220b will be referred to as sessions ranking module 220.

The network 105 enables communications between user devices 115a, 115b, the social network server 101 and the third part application server 107. Thus, the network 105 can include links using technologies such as Wi-Fi, Wi-Max, 2G, Universal Mobile Telecommunications System (UMTS), 3G, Ethernet, 802.11, integrated services digital network (ISDN), digital subscriber line (DSL), asynchronous transfer mode (ATM), InfiniBand, PCI Express Advanced Switching, etc. Similarly, the networking protocols used on the network 105 can include the transmission control protocol/Internet protocol (TCP/IP), multi-protocol label switching (MPLS), the User Datagram Protocol (UDP), the hypertext transport protocol (HTTP), the simple mail transfer protocol (SMTP), the file transfer protocol (FTP), lightweight directory access protocol (LDAP), Code Division Multiple Access (CDMA), Wideband Code Division Multiple Access (WCDMA), Global System for Mobile communications (GSM), High-Speed Downlink Packet Access (HSDPA), etc. The data exchanged over the network 105 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs) or Internet Protocol security (IPsec). In another embodiment, the entities can use custom and/or dedicated data communications technologies instead of, or in addition to, the ones described above. Depending upon the embodiment, the network 105 can also include links to other networks.

In one embodiment, the network 105 is a partially public or a wholly public network such as the Internet. The network 105 can also be a private network or include one or more distinct or logical private networks (e.g., virtual private networks, Wide Area Networks (“WAN”) and/or Local Area Networks (“LAN”)). Additionally, the communication links to and from the network 105 can be wireline or wireless (i.e., terrestrial—or satellite-based transceivers). In one embodiment, the network 105 is an IP-based wide or metropolitan area network.

In the illustrated embodiment, the user device 115a is coupled to the network 105 via signal line 108. The user 125a can interact with the user device 115a as illustrated by signal line 116. The user device 115b is coupled to the network via signal line 112. The user 125b is can interact with the user device 115b as illustrated by signal line 114. The third party application server 107 is communicatively coupled to the network 105 via signal line 106. The social network server 101 is communicatively coupled to the network 105 via signal line 104. The social network server 101 is also communicatively coupled to data storage 110 via signal line 102.

Data storage 110 stores data and information of users 125a/125b/125n of the social network system 100. Such stored information includes user profiles and other information identifying the users 125a/125b/125n of the social network system 100. Examples of information identifying users includes, but is not limited to, the user's name, contact information, sex, relationship status, likes, interests, links, education and employment history, location, political views, and religion. In one embodiment, the information stored in data storage 110 also includes the user's list of current and past friends and the user's activities within the social network system 100, such as anything the user posts within the social network system and any messages that the user sends to other users.

In one embodiment, a user device 115a, 115b, . . . or 115n is an electronic computing device having a web browser for interacting with the social network server 101 via the network 105 and is used by user 125a, 125b, 125n to access information in the social network system 100. The user device 115a, 115b, 115n can be a computing device, for example, a laptop computer, a desktop computer, a tablet computer, a mobile telephone, a personal digital assistant (PDA), a mobile email device, a portable game player, a portable music player, a television with one or more processors embedded therein or coupled thereto, or any other electronic device capable of accessing a network. A server can also be a computing device.

### Example Social Network Server

FIG. 2 is a block diagram of an embodiment of a social network server 101 in accordance with one embodiment. As illustrated in FIG. 2, the social network server 101 includes a network adapter 202 coupled to a bus 204. Also coupled to the bus 204 are at least one processor 206, memory 208, a graphics adapter 210, an input device 212 and a storage device 214. In one embodiment, the functionality of the bus 204 is provided by an interconnecting chipset. The social network server 101 also includes a display 222, which is coupled to the graphics adapter 210. As illustrated in FIG. 2, embodiments of a social network server 101 can include a social network module 209, a communication module 216, a sessions identifier module 218 and a sessions ranking module 220.

The processor 206 may be any general-purpose processor. The processor 206 comprises an arithmetic logic unit, a microprocessor, a general purpose controller or some other processor array to perform computations, provide electronic display signals to display 222. The processor 206 is coupled to the bus 204 for communication with the other components of the user device 115a/115b. Processor 206 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The user device 115a/115b also includes an operating system executable by the processor such as but not limited to WINDOWS®, MacOS X, Android, or UNIX® based operating systems.

The memory 208 holds instructions and data used by the processor 206. The instructions and/or data comprise code for performing any and/or all of the techniques described herein. The memory 208 may be a dynamic random access memory (DRAM) device, a static random access memory (SRAM) device, flash memory or some other memory device known in the art. In one embodiment, the memory 208 also includes a non-volatile memory such as a hard disk drive or flash drive for storing log information on a more permanent basis. The memory 208 is coupled by the bus 204 for communication with the other components of the user device 115a/115b.

The storage device 214 is any device capable of holding data, like a hard drive, compact disk read-only memory (CD-ROM), DVD, or a solid-state memory device. The storage device 214 is a non-volatile memory device or similar permanent storage device and media. The storage device 214 stores data and instructions for processor 206 and comprises one or more devices including a hard disk drive, a floppy disk drive, a CD-ROM device, a DVD-ROM device, a DVD-RAM device, a DVD-RW device, a flash memory device, or some other mass storage device known in the art.

The input device 212 may be a mouse, track ball, or other type of pointing device, and is used in combination with another input device 212, such as a keyboard to input data into the social network server 101. The graphics adapter 210 displays images and other information on the display 222. The display 222 is a conventional type such as a liquid crystal display (LCD) or any other similarly equipped display device, screen, or monitor. The display 222 represents any device equipped to display electronic images and data as described herein. The network adapter 202 couples the social network server 101 to a local or wide area network.

In one embodiment, the social network module 209 is software and/or routines executable by a processor to control the interaction between the social network server 101, storage device 214 and the user devices 115a, 115b, 115n. An embodiment of the social network module 209 allows users 125a, 125b, 125n of user devices 115a, 115b, 115n to perform social functions between other users 125a, 125b, 125n of user devices 115a, 115b, 115n within the social network system 100.

The communication module 216 is software and/or routines that, when executed by a processor, allow for communication between users 125 of user devices 115. In some embodiments, the communication module 216 facilitates audio communication between users 125 of user devices 115. In other embodiments, communication module 216 facilitates video communication between users 125 of user devices 115. In yet other embodiments, the communication module 216 facilitates both audio communication and video communication between users 125 of user devices 115. In some embodiments, the communication module 216 facilitates simultaneous audio and/or video communication between multiple users 125 of user devices 115. In some embodiments, the previously-identified audio and/or video communication includes synchronous communication sessions. In some embodiments, the communication module 216 manages the synchronous communication sessions. In some embodiments, the synchronous communication sessions are initiated within a social network portal and the communication associated with the synchronous communication sessions includes communication between users of the social network portal.

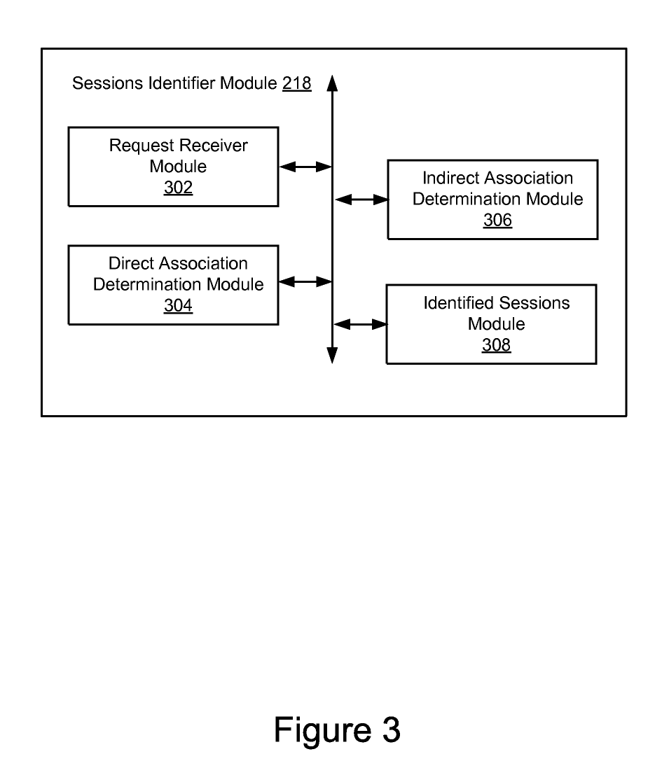

The sessions identifier module 218 is software and/or routines that, when executed by a processor, monitors existing synchronous communication sessions and identifies existing synchronous communication sessions associated with a particular user. In some embodiments, the sessions identifier module 218 identifies existing communication sessions where the user has access. In other embodiments, the sessions identifier module 218 identifies existing communication sessions that have participants who are associated with the user, either directly as a connection or indirectly. In other embodiments, the sessions identifier module 218 identifies both types of the aforementioned sessions. Details describing the components and functionality of the sessions identifier module 218 will be described in further detail below with regard to FIG. 3. In some embodiments, the system will not identify a synchronous communication session with a user unless the creator and/or participants in that synchronous communication session have specifically shared the session with the user. Embodiments may associate synchronous communication sessions with a user unless the creator and/or participants have specifically opted out of that synchronous communication session being shared.

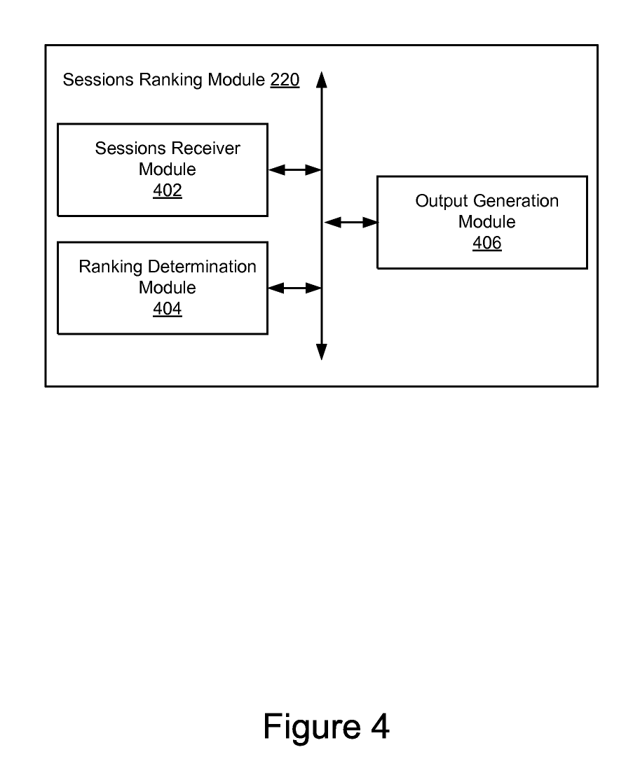

The sessions ranking module 220 is software and/or routines that, when executed by a processor, analyzes the identified sessions and ranks at least a subset of the sessions based on predefined criteria. In some embodiments, the sessions ranking module 220 ranks at least a subset of the sessions and generates an order for display based on the rank. Details describing the components and functionality of the sessions ranking module 220 will be described in further detail below with regard to FIG. 4.

As is known in the art, the social network server 101 can have different and/or other components than those shown in FIG. 2. As is known in the art, the social network server 101 is adapted to execute computer program modules for providing functionality described herein. As used herein, the term “module” encompasses it plain and ordinary meaning, including, but not limited to computer program logic utilized to provide the specified functionality. Thus, a module can be implemented in hardware, firmware, and/or software. In one embodiment, program modules are stored on the storage device 214, loaded into the memory 208, and executed by the processor 206.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Example Sessions Identifier Module

FIG. 3 is a block diagram illustrating modules within the sessions identifier module 218 according to one embodiment. As stated above, in various embodiments, the sessions identifier module 218 may be software and/or routines executable by the processor to identify existing synchronous communications sessions associated with a user. According to one embodiment, the sessions identifier module 218 includes a request receiver module 302, a direct association determination module 304, an indirect association determination module 306 and an identified sessions module 308. In some embodiments, one or more of these modules are implemented together and are embodied as a single module. For example, direct association determination module 304 may be implemented with the indirect association determination module 306 as a single association determination module (not pictured).

In one embodiment, the sessions identifier module 218 is configured to communicate with user devices 115 to receive requests from the user devices 115. In some embodiments, the sessions identifier module 218 is configured to communicate with the user devices 115 to send information related to identified existing synchronous communications sessions for display on the user devices 115. In some embodiments, the request received from the user devices 115 is a request to view information of a user 125. In some embodiments, the sessions identifier module 218 is also configured to communicate with the communication module 216 to monitor existing synchronous communication sessions and receive information about the existing communication sessions. In other embodiments, the sessions identifier module 218 is configured to communicate with the communication module 216 to monitor existing synchronous communication sessions and identifier the existing synchronous communication sessions that are associated with the user based on information received from a request from the user.

The request receiver module 302 of the sessions identifier module 218 is software and/or routines for receiving a request from a user device 115. In some embodiments, the request received from the user devices 115 is a request to view information of a user 125. In some embodiments, the request received by the request receiver module 302 includes information identifying the user. The request receiver module is configured to communicate with the association module 304 and sends the information associated with the user 125 to the association module 304.

The direct association module 304 of the sessions identifier module 218 is software and/or routines for receiving information about a user and identifying synchronous communication sessions associated with the user. The direct association module 304 is configured to communicate with the request receiver module 302 to receive the information about the user. The direct association module 304 is also configured to communicate with the communication module 216 to retrieve information about synchronous communication sessions that are managed by the communication module 216. In some embodiments, the direct association module 304 monitors the synchronous communication sessions managed by the communication module 216 and retrieves information about existing synchronous communication sessions. An existing synchronous communication session is a synchronous communication session that is currently populated with participants communicating with each other. In some embodiments, the communication may be through video communication. In other embodiments, the communication may be through audio communication. In other embodiments, the communication may be through both audio and video communication.

In some embodiments, the direct association module 304 retrieves information about existing synchronous communication sessions and identifies the existing synchronous communication sessions that the user has access to. For example, each synchronous communication session may have a list of invitees, and the direct association module 304 identifies which existing communication session has the user listed as an invitee based on the identifying information related to the user that was received.

The indirect association module 306 of the sessions identifier module 218 is software and/or routines for receiving information about a user and identifying synchronous communication sessions associated with the user. The indirect association module 306 is configured to communicate with the request receiver module 302 to receive the information about the user. The indirect association module 306 is also configured to communicate with the communication module 216 to retrieve information about synchronous communication sessions that are managed by the communication module 216. Similar to the direct association module 304, in some embodiments, the indirect association module 306 monitors the synchronous communication sessions managed by the communication module 216 and retrieves information related existing synchronous communication sessions. An existing synchronous communication session is a synchronous communication session that is currently populated with participants communicating with each other. In some embodiments, the communication may be through video communication. In other embodiments, the communication may be through audio communication. In other embodiments, the communication may be through both audio and video communication. In some embodiments, the indirect association module 306 is also configured to communicate with the social network module 209 to retrieve information associated with participants of the existing synchronous communication sessions.

In some embodiments, the indirect association module 306 retrieves information related to existing synchronous communication sessions and identifies the existing synchronous communication sessions that have some association with the user. In some embodiments, the indirect association module 306 retrieves information related to existing synchronous communication sessions and identifies the existing synchronous communication sessions that have participants that have an indirect relationship or association with the user. For example, the indirect association module 306 determines if any of the participants of the existing synchronous communication session has an indirect relationship or connection with the user. For example, an indirect relationship may be if the participant has added the user as a connection, but the user has not added the participant as a connection.

The identified sessions module 308 of the sessions identifier module 218 is software and/or routines for keeping track of the identified existing communication sessions associated with the user. The identified sessions module 308 is configured to communicate with direct association determination module 304 to receive information related to the identified existing communication sessions directly associated with the user. The identified sessions module 308 is also configured to communicate with the indirect association determination module 306 to receive information related to the identified existing communication sessions indirectly associated with the user.

The identified sessions module 308 of the sessions identifier module 218 keeps track of these identified existing communication sessions associated with the user and in some embodiments, sends information related to the identified existing communication sessions associated with the user to the ranking module 220 of the social network server 101.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Example Sessions Ranking Module

FIG. 4 is a block diagram illustrating modules within the sessions ranking module 220 according to one embodiment. As stated above, in various embodiments, the sessions ranking module 220 may be software and/or routines executable by the processor to rank existing communication sessions. According to one embodiment, the sessions identifier module 218 includes a sessions receiver module 402, a rank determination module 404 and an output generation module 406.

In one embodiment, the sessions ranking module 220 is configured to communicate with the sessions identifier module 218 to receive information related to the identified existing communication sessions associated with the user. In some embodiments, the sessions ranking module 220 is also configured to communicate with the user devices 115 to send information about the ranked existing communications sessions for display on the user devices 115.

In one embodiment, the sessions receiver module 402 is software and/or routines that, when executed by a processor, receive information related to the identified existing synchronous communication sessions from the sessions identifier module 218. The sessions receiver module 402 received the information related to the identified existing synchronous communication sessions and send the information to the rank determination module 404.

In one embodiment, the rank determination module 404 is software and/or routines that, when executed by a processor, rank the received identified synchronous communication sessions. The rank determination module 404 is configured to communicate with the sessions receiver module 402 to receive information related to the identified synchronous communication sessions. The rank determination module 404 is also configured to communicate with the output generation module 406 and sends the ranked identified synchronous communication sessions to the output generation module 406 for sending to the user devices 115 for display.

In some embodiments, the rank determination module 404 ranks the identified synchronous communication sessions based on an affinity between the user and the synchronous communication session. Affinity may be based on, for example, the number of time a user has communicated with participants of a synchronous communication session, the number of connections the user has with participants within a synchronous communication session, or whether the participants are part of a coherent unit, among other factors. In some embodiments, the rank determination module 404 ranks the synchronous communication session based on how many participants of the synchronous communication session have a connection with the user. In some embodiments, the more connections the user has with the participants of the synchronous communication session, the higher the rank of the synchronous communication session will be. In some embodiments, the rank determination module 404 ranks the synchronous communication sessions based on the strength of the connections between the users and the participants of the synchronous communication session. For example, the more direct connections, the higher the rank. Indirect connections would produce a lower ranking. Further, in some embodiments, the rank could be higher if the user has engaged in synchronous communication sessions with the participants in the synchronous communication sessions previously, with the greater number of past synchronous communication sessions indicating a higher rank. Furthermore, in some embodiments, the rank may also be higher if the participants in the synchronous communication session are a coherent unit, for example, a coherent unit may be a group of participants who are connected within an organized group within a social network and are engaged in a synchronous communication session (e.g., a circle of family members). In some embodiments where the rank is increased, the rank determination module 404 may mathematically increase a stored number indicating the rank.

In one embodiment, the output generation module 406 is software and/or routines that, when executed by a processor, generates an indication of one of the identified existing communication sessions for display on the user devices 115. The output generation module 406 is configured to communicate with the rank determination module 404 and receives the ranked identified synchronous communications sessions from the rank determination module 404. In some embodiments, the output generation module 406 is configured to communicate with the storage device 214 to retrieve information related to the participants of the synchronous communications sessions to generate indications or represents of some of the participants of the synchronous communications sessions along with the indication of the synchronous communications sessions.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Example Process

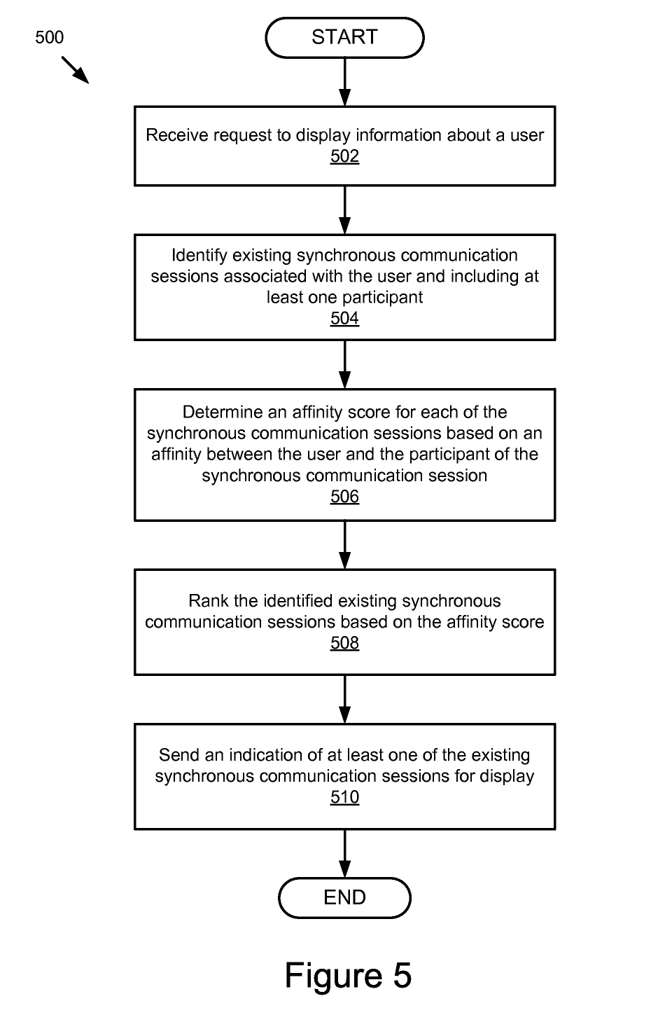

Referring now to FIG. 5, an embodiment of a method 500 for identifying existing synchronous communication sessions associated with a user will be described. In some embodiments, the method 500 is performed by the components of the social network server 101. In one embodiment, the method 500 begins when a request to display information about a user is received 502 by the sessions identifier module 218. In some embodiments, the request includes information identifying a user. Based on the identifying information, existing synchronous communication sessions associated with the user are identified 504 by the sessions identifier module 218. In some embodiments, the identified synchronous communication sessions include at least one participant.

An affinity score for each existing synchronous communication session is determined 506 by the sessions ranking module 220. In some embodiments, the affinity score for each existing synchronous communication session is based on an affinity between the user and the participant of the synchronous communication session. In some embodiments, the affinity score for each existing synchronous communication session is based on the number of connections the user has with the participants of the existing synchronous communication session. Other examples of calculating an affinity score are given elsewhere herein.

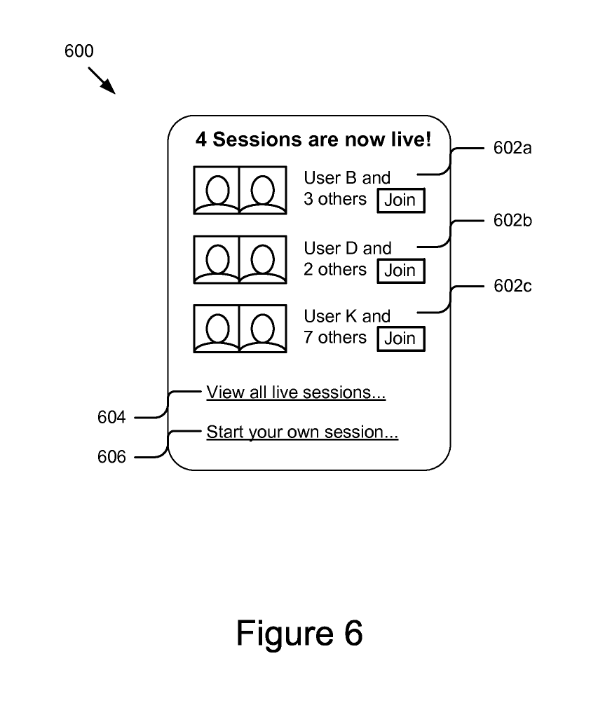

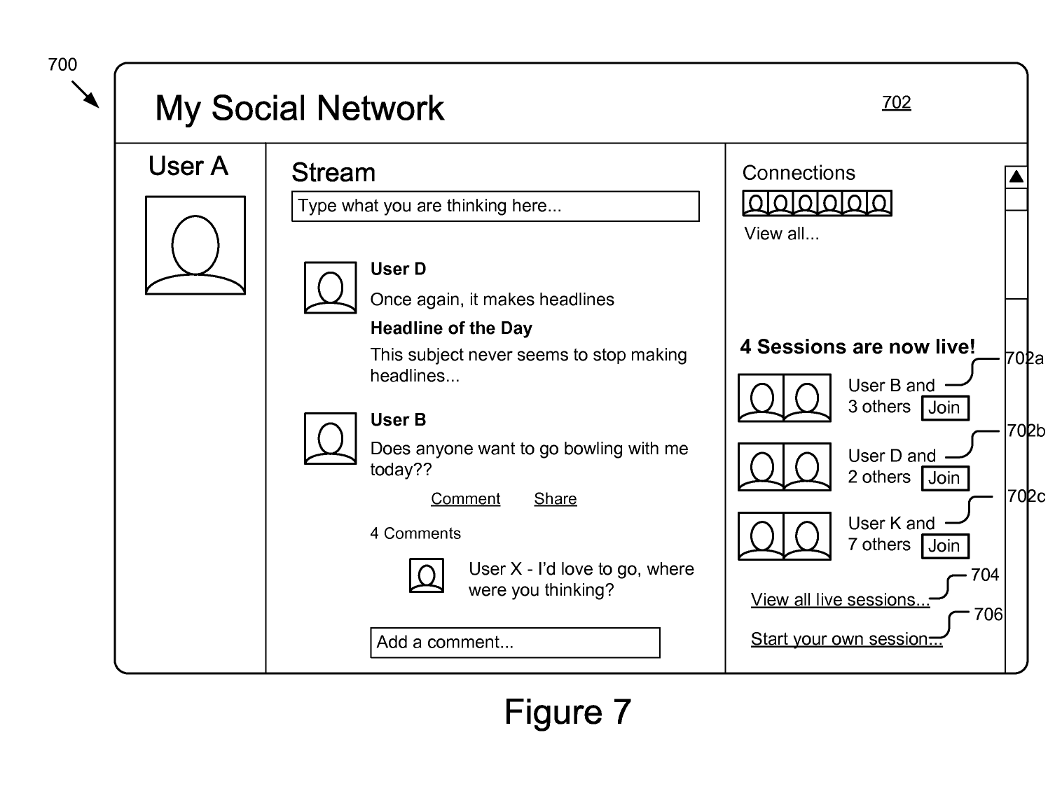

The identified existing communication sessions are ranked 508 based on the determined affinity score by the sessions ranking module 220. For example, the higher the affinity score, the higher the rank. An indication of at least one of the identified existing synchronous communication sessions is sent 510 for display by the sessions ranking module 220. For example, as seen in FIG. 6, indications 602a, 602b and 602c show identified existing communication sessions. Similarly, as seen in FIG. 7, indications 702a, 702b and 702c show identified existing communication sessions.

### Example User Interfaces

Now turning to FIG. 6, an example user interface 600 for displaying indications of identified existing synchronous communication sessions associated with a user is illustrated. In some embodiments, the user interface 600 may be a pop-up window that appears upon receiving a request to display information about a user. As shown in FIG. 6, user interface 600 includes indications 602a, 602b and 602c of existing synchronous communication sessions that are associated with a user. According to the embodiment illustrated in FIG. 6, the indications 602a, 602b and 602c show an identifier for one participant of the existing synchronous communication session and the number. According to the embodiment illustrated in FIG. 6, the indications 602a, 602b and 602c also show an icon associated with two of the participants of the existing synchronous communication session. Other embodiments may show different and/or additional information. User interface 600 also includes a link 604 to view the other identified existing synchronous communication sessions and a link 606 to start a synchronous communication session.

FIG. 7 illustrates another embodiment of another user interface 700 for displaying indications of identified existing synchronous communication sessions associated with a user. Interface 700 shows a web portal 702 of a social network. Similar to user interface 600, user interface 700 includes indications 702a, 702b and 702c of existing synchronous communication sessions that are associated with a user. According to the embodiment illustrated in FIG. 7, the indications 602a, 602b and 602c show an identifier for one participant of the existing synchronous communication session and the number. According to the embodiment illustrated in FIG. 6, the indications 602a, 602b and 602c also show an icon associated with two of the participants of the existing synchronous communication session. Other embodiments may show different and/or additional information. User interface 700 also includes a link 704 to view the other identified existing synchronous communication sessions and a link 706 to start a synchronous communication session.

### Second Example Process

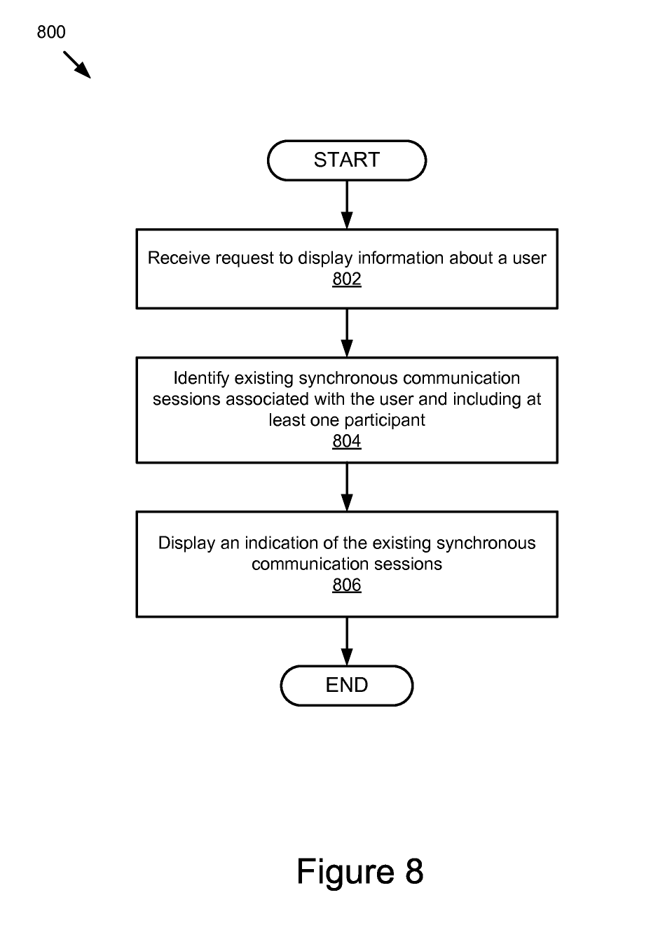

Referring now to FIG. 8, another embodiment of a method 800 for identifying existing synchronous communication sessions associated with a user will be described. In some embodiments, the method 800 is performed by the components of the social network server 101. In one embodiment, the method 800 begins when a request to display information about a user is received 802 by the sessions identifier module 218. For example, this request may happen when a user logs into the user's social network account. In some embodiments, the request includes information identifying a user. Based on the identifying information, existing synchronous communication sessions associated with the user are identified 804 by the sessions identifier module 218. In some embodiments, the identified synchronous communication sessions include at least one participant. An indication of the identified existing synchronous communication sessions is sent 806 for display by the sessions identifier module 218. For example, as shown in FIG. 6, indications 602a, 602b and 602c show identified existing communication sessions. Similarly, as seen in FIG. 7, indications 702a, 702b and 702c show identified existing communication sessions.

### Sample User Interfaces

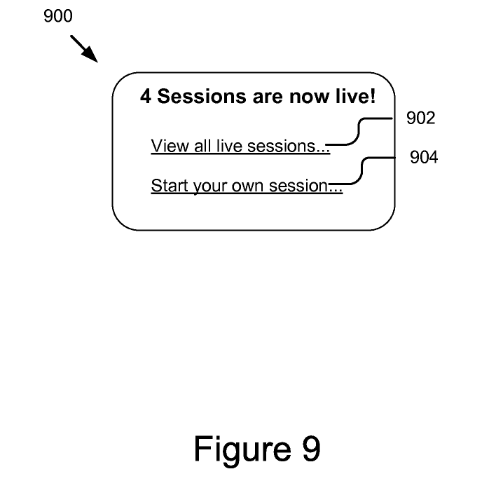

Now turning to FIG. 9, an example user interface 900 for displaying indications of identified existing synchronous communication sessions associated with a user is illustrated. Similar to the embodiment shown in FIG. 6, the embodiment shown in FIG. 9 shows the user interface 900 as a pop-up window that appears upon receiving a request to display information about a user. User interface 900 also includes a link 902 to view the other identified existing synchronous communication sessions and a link 904 to start a synchronous communication session. Other embodiments may show different and/or additional information.

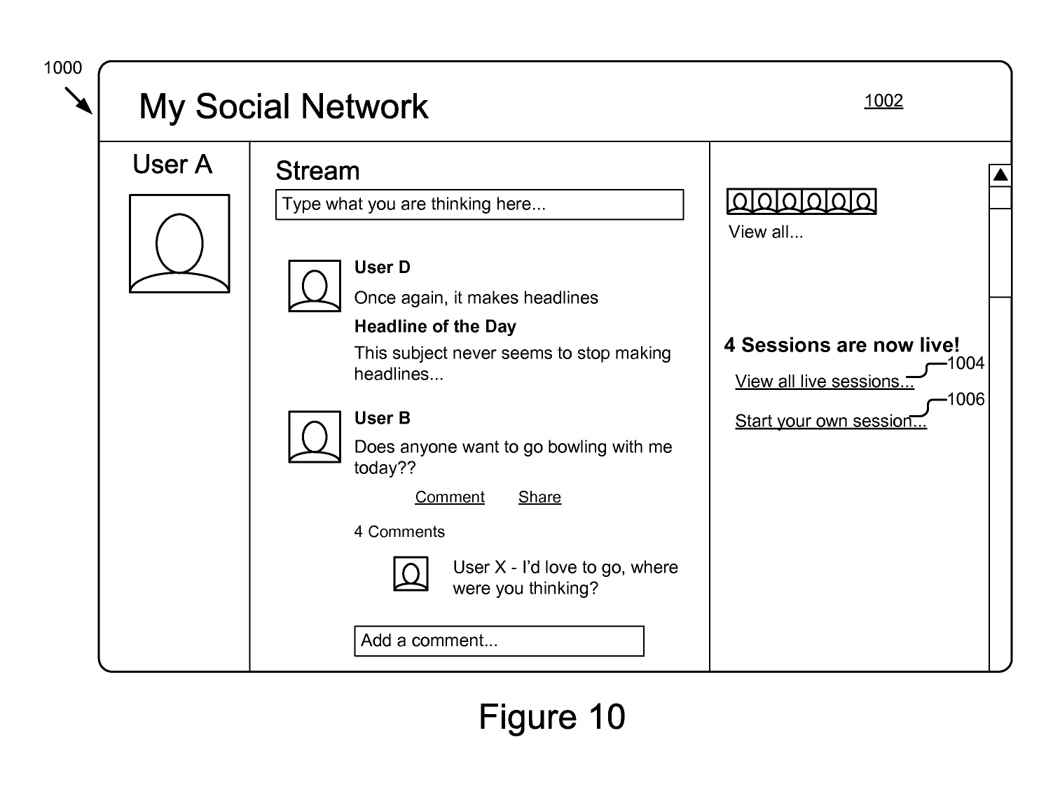

FIG. 10 illustrates another embodiment of another user interface 1000 for displaying indications of identified existing synchronous communication sessions associated with a user. Interface 1000 shows a web portal 1002 of a social network. Similar to user interface 900, user interface 1000 includes a link 1004 to view the other identified existing synchronous communication sessions and a link 1006 to start a synchronous communication session.

The foregoing data/information can be collected upon user consent for generating, e.g., prediction models. In some implementations, a user can be prompted to explicitly allow data collection. Further, the user may opt in/out of participating in such data collection activities. Furthermore, the collected data can be anonymized prior to performing the analysis to obtain the various statistical patterns described above.

The foregoing data/information can be collected upon user consent for generating, e.g., prediction models. In some implementations, a user can be prompted to explicitly allow data collection. Further, the user may opt in/out of participating in such data collection activities. Furthermore, the collected data can be anonymized prior to performing the analysis to obtain the various statistical patterns described above

The foregoing description of the embodiments of the present disclosure has been presented for the purposes of illustration and description. It is not intended to be exhaustive or to limit the present embodiments to the precise form disclosed. Many modifications and variations are possible in light of the above teaching. It is intended that the scope of the present embodiments be limited not by this detailed description, but rather by the claims of this application. As will be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present embodiments or their features may have different names, divisions and/or formats. Furthermore, as will be apparent to one of ordinary skill in the relevant art, the modules, routines, features, attributes, methodologies and other aspects of the present embodiments can be implemented as software, hardware, firmware or any combination of the three. Also, wherever a component, an example of which is a module, of the present embodiments are implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present embodiments are in no way limited to implementation in any specific programming language, or for any specific operating system or environment. Accordingly, the disclosure is intended to be illustrative, but not limiting, of the scope of the present embodiments, which is set forth in the following claims.

1. A method of identifying existing synchronous communication sessions associated with a user performed by one or more computing devices, the method comprising:
generating and displaying indications of a subset of a plurality of existing synchronous communication sessions in response to receiving a social network login request, the social network login request including information identifying the user and causing the one or more computing devices to display the subset of the plurality of existing synchronous communication sessions along with social network information on a social network portal of the user;
wherein generating the indications of the subset of the plurality of existing synchronous communication sessions includes:
identifying the plurality of existing synchronous communication sessions, wherein each of the plurality of existing synchronous communication sessions includes a plurality of participants and wherein the user has an association with each of the plurality of existing synchronous communication sessions;
determining, using the one or more computing devices, an affinity score for each of the plurality of existing synchronous communication sessions based on a number of contacts in common between the user and the plurality of participants, the contacts being users each having a direct or indirect social connection with each participant of the plurality of participants;
ranking the plurality of existing synchronous communication sessions based on the affinity score to generate an order of affinity; and
wherein displaying the indications of the subset of the plurality of existing synchronous communication sessions includes providing for display on the social network portal of the user, using the one or more computing devices, indications of the subset of the plurality of existing synchronous communication sessions based on the order of affinity.

2. The method of claim 1, wherein providing for display of the indications, further includes:
providing for display of a representation of at least one participant of the plurality of participants.

3. The method of claim 1, wherein the method further comprises displaying, on a computing device associated with the user, the indications of the subset of the plurality of existing synchronous communication sessions based on the order of affinity.

4. The method of claim 1, wherein the request is received from the user.

5. The method of claim 1, wherein the request includes identifying information related to the user.

6. The method of claim 1, wherein determining the affinity score for each of the plurality of existing synchronous communication sessions includes retrieving information related to at least one participant of the plurality of participants.

7. (canceled)

8. (canceled)

9. The method of claim 1, wherein determining the affinity score for each of the plurality of existing synchronous communication sessions is based on a similarity between the user and at least one participant of the plurality of participants.

10. The method of claim 1, wherein determining the affinity score for each of the plurality of existing synchronous communication sessions is based on a history of the user engaging in a previous synchronous communication session with at least one participant of the plurality of participants.

11. The method of claim 1, wherein determining the affinity score for each of the plurality of existing synchronous communication sessions is based on the user and at least one participant of the plurality of participants being in a coherent group.

12. A system for identifying existing synchronous communication sessions associated with a user, the system comprising:
a processor;
a non-transitory computer usable memory storing instructions that when executed by the processor cause the system to perform operations, including generating and displaying indications of a plurality of existing synchronous communication sessions in response to receiving a social network login request;
a request receiver for receiving the social network login request, the social network login request including information identifying the user and causing the system to display at least one of the plurality of existing synchronous communication sessions along with social network information on a social network portal of the user;
an sessions identifier for identifying the plurality of existing synchronous communication sessions wherein each of the plurality of existing synchronous communication sessions includes a plurality of participants and wherein the user has an association with each of the plurality of existing synchronous communication sessions;
a sessions ranking module for determining an affinity score for each of the plurality of existing synchronous communication sessions based on a number of contacts in common between the user and the plurality of participants and for ranking the plurality of existing synchronous communication sessions based on the affinity score to generate an order of affinity, the contacts being users each having a direct or indirect social connection with each participant of the plurality of participants; and
an output generator for sending indications of the at least one of the plurality of existing synchronous communication sessions for display on the social network portal of the user.

13. The system of claim 12, wherein sending the indications, further includes:
displaying a representation of at least one participant of the plurality of participants.

14. The system of claim 12, wherein the request is received from the user.

15. The system of claim 12, wherein the request includes identifying information related to the user.

16. The system of claim 12, wherein determining the affinity score for each of the plurality of existing synchronous communication sessions includes retrieving information related to at least one participant of the plurality of participants.

17. (canceled)

18. (canceled)

19. A non-transitory computer readable medium with encoded instructions thereon that, in response to execution by one or more computing devices, cause the one or more computing devices to perform operations comprising:
generating and displaying indications of a subset of a plurality of existing synchronous communication sessions in response to receiving a social network login request, the social network login request including information identifying the user and causing the one or more computing devices to display the subset of the plurality of existing synchronous communication sessions along with social network information on a social network portal of the user;
wherein generating the indications of the subset of the plurality of existing synchronous communication sessions includes:
identifying the plurality of existing synchronous communication sessions wherein each of the plurality of existing synchronous communication sessions includes a plurality of participants and wherein the user has an association with each of the plurality of existing synchronous communication sessions;
determining an affinity score for each of the plurality of existing synchronous communication sessions based on a number of contacts in common between the user and the plurality of participants, the contacts being users each having a direct or indirect social connection with each participant of the plurality of participants;
ranking the plurality of existing synchronous communication sessions based on the affinity score to generate an order of affinity; and
wherein displaying the indications of the subset of the plurality of existing synchronous communication sessions includes displaying on the social network portal of the user, on the one or more computing devices, indications of the subset of the plurality of existing synchronous communication sessions based on the order of affinity.

20. The non-transitory computer readable medium of claim 19, wherein displaying the indications, further includes:
displaying a representation of at least one participant.

21. The non-transitory computer readable medium of claim 19, wherein the request is received from the user.

22. The non-transitory computer readable medium of claim 19, wherein the request includes identifying information related to the user.

23. The non-transitory computer readable medium of claim 19, wherein determining the affinity score for each of the plurality of existing synchronous communication sessions includes retrieving information related to at least one participant of the plurality of participants.

24. (canceled)

25. (canceled)

26. A system for identifying existing synchronous communication sessions associated with a user, the system comprising:
a processor;
a non-transitory computer usable memory storing instructions that when executed by the processor cause the system to perform operations, including generating and displaying indications of a plurality of existing synchronous communication sessions in response to receiving a social network login request;
an input receiver for receiving the social network login request, the social network login request including information identifying the user and causing the system to display at least one of the plurality of existing synchronous communication sessions along with social network information on a social network portal of the user;
an identifier for identifying the plurality of existing synchronous communication sessions wherein each of the plurality of existing synchronous communication sessions includes a plurality of participants and wherein the user has an association with each of the plurality of existing synchronous communication sessions;
a rank calculator for determining an affinity score for each of the plurality of existing synchronous communication sessions based on a number of contacts in common between the user and the plurality of participants and for ranking the plurality of existing synchronous communication sessions based on the affinity score to generate an order of affinity, the contacts being users each having a direct or indirect social connection with each participant of the plurality of participants; and
an output generator for sending the indications of the at least one of the plurality of existing synchronous communication sessions for display on the social network portal of the user.

27. The system of claim 26, wherein displaying the indications, further includes:
displaying a representation of at least one participant of the plurality of participants.

28. The system of claim 26, wherein the request is received from the user.

29. The system of claim 26, wherein the request includes identifying information related to the user.
